(19) United States
(12) Patent Application Publication
(10) Pub. No.: US 2022/0280265 A1
(43) Pub. Date: Sep. 8, 2022

(54) KINEMATIC APPARATUS

(71) Applicant: Candid Care Company, New York, NY (US)

(72) Inventor: Philip W Hobden, San Jose, CA (US)

(73) Assignee: Candid Care Company, New York, NY (US)

(21) Appl. No.: 17/195,462

(22) Filed: Mar. 8, 2021

(51) Int. Cl. A61C 7/00; A61C 7/08; A61C 13/00

(52) U.S. Cl. CPC A61C 7/002; A61C 7/08; A61C 13/0019; A61C 13/0018; A61C 2007/004

(57) ABSTRACT

A nest with flexural self-alignment features for receiving and aligning a model. The model is provided is a pair of V grooves that engage a pair of alignment pins of the nest. One of the alignment pins is movable and is connected to a near-infinite-life spring loaded flexure.

### TECHNICAL FIELD

The disclosure relates generally to a kinematic apparatus and, more specifically, to a kinematic nest having a flexure and kinematic mount embedded therein to secure and repeatedly locate a model.

### BACKGROUND

Thermoforming is used in manufacturing processes to create specific shapes for a product. A sheet such as a plastic sheet is heated to a pliable forming temperature that allows it to be stretched into or onto a mold and cooled to a defined shape. After forming the defined shape, the plastic is usually picked up and placed a number of times in an automatic and/or manual process down the manufacturing line in order to create a final finished product.

In any manufacturing process, for example in an automated process, the consistency at which an arm such as a pick and place robot arm is able to complete thermoforming, assembly, quality control, packaging and other material handling processes improves the overall quality of production and reduces downtime due to errors. Speed contributes significantly to productivity, as pick and place robots move products through the manufacturing process much quicker than manual options. For example, in aligner manufacturing it is a goal to produce a plurality of aligners to desired specifications at a fast throughput. However, challenges arise when there are manufacturing errors in the sizes of molds or models on which a plastic for producing an aligner is thermoformed. With these errors, it is usually difficult to precisely locate the thermoformed plastic and/or model in a repeatable fashion throughout the manufacturing process. For example, a model in a patient treatment plan might differ from another one by, for example, one thousandths of an inch. Assuming 60 models are needed for one treatment plan, the errors in the manufacturing process can accumulate quickly resulting in an inability to precisely locate the models in a manufacturing process that involves several steps of picking up and placing the model in a determinate manner.

### SUMMARY

The illustrative embodiments provide an apparatus, method, computer system and a computer readable media.

In an aspect herein, the apparatus is any apparatus that needs to hold secure a model in a defined position for subsequent work on the model such as a thermoforming apparatus, a Computer Numerical Control (CNC) apparatus, laser marking apparatus or otherwise kinematic apparatus. The kinematic apparatus includes: a nest; a lower mount, which may be the nest or a part of the nest, that includes a plurality of pins arranged in the nest to conform to Maxwell's criterion when coupled with an upper mount such as a an external clamping method (or gravity in the absence of an upper mount), in order to repeatedly locate a model,; and a flexure embedded in the nest and connected to an alignment pin that is movable, the flexure is configured to move jointly with the alignment pin that is movable. In the apparatus, another alignment pin is embedded in the thermoforming nest, is stationary, and engages a first groove of the model. In the apparatus, the alignment pin that is movable is configured to engage a second groove of the model and move jointly with the flexure which uses a spring resistance to motion to secure the model on the mount.

In another aspect herein, any combination of the following features are provided: (i) the first and second grooves are sideways v-grooves, (ii) the plurality of pins are four, (iii) the thermoforming nest is configured to receive a 3D printed dental arch model in order to thermoform an aligner on the 3D printed dental arch model, (iv) the flexure is movable in the X direction and unmovable in the Y and Z directions, (v) the flexure is movable from an original position to a maximum position in order to secure any model size that is between a minimum and a maximum size respectively, (vi) a thickness of the flexure is designed to produce a slit in the thermoforming nest, wherein in the original position, the flexure is a first distance from a first edge of the slit and in the maximum position, the flexure is a second distance from the first edge of the slit, wherein a difference between the first and second distances is chosen to accommodate tolerances of the model, (vii) the mount is over constrained, the thermoforming disc is made of a polymer material having a substantially constant thickness.

In yet another aspect herein, a method is provided. The method includes providing a thermoforming nest with a flexure and a kinematic mount having a plurality of pins, the plurality of pins are arranged to mate with surfaces of a thermoformed disc to conform to Maxwell's criterion in order to repeatedly locate the model; providing the model with a number of v-grooves; securing the model on the kinematic mount of the thermoforming nest by using said number of v-grooves to engage corresponding pins of the plurality of pins of the kinematic mount; and. placing the first material on the model and thermoforming said first material around the model and the plurality of pins such that a negative of the model and the plurality of pins is formed in the first material. In the method, the flexure is connected to an alignment pin of the corresponding pins, the alignment pin being movable and moving jointly with the flexure such that when one v-groove of the model engages the movable pin, the flexure moves with spring resistance to motion, in order to accommodate any size of the model that is between a defined minimum and maximum size.

In another aspect, one or more combinations of the following are provided: (i) the model is a 3D printed dental arch model, (ii) the first material that is thermoformed, together with the dental arch model in the thermoforming nest forms a quasi-Maxwell kinematic coupling which is subsequently obtained by an external device and repeatedly located relative to a reference point, (iii) trimming the first material that is thermoformed on the dental arch model along a gum line of the dental arch model to produce an aligner, (iv) the providing, securing and placing steps are repeatable to produce a plurality of other aligners from a corresponding plurality of other dental arch models using the same thermoforming nest.

In yet another aspect, a computer system is provided. The computer system comprises at least one processor operable to perform the steps of: obtaining a thermoforming nest provided with a flexure and a kinematic mount having a plurality of pins, the plurality of pins are arranged to mate with surfaces of a thermoformed disc to conform to Maxwell's criterion in order to repeatedly locate the model; obtaining the model, the model being provided with a number of v-grooves; securing the model on the kinematic mount of the thermoforming nest by using said number of v-grooves to engage corresponding pins of the plurality of pins of the kinematic mount; placing the first material on the model and thermoforming said first material around the model and the plurality of pins such that a negative of the model and the plurality of pins is formed in the first material, wherein the flexure is connected to an alignment pin of the corresponding pins, the alignment ping being movable and moving jointly with the flexure such that when one v-groove of the model engages the movable pin, the flexure moves with spring resistance to motion, in order to accommodate any size of the model that is between a defined minimum and maximum size.

In an even further aspect herein, a non-transitory computer-readable storage medium is provided. It stores a program which, when executed by a computer system, causes the computer system to perform a procedure comprising: obtaining a thermoforming nest provided with a flexure and a kinematic mount having a plurality of pins, the plurality of pins are arranged to mate with surfaces of a thermoformed disc to conform to Maxwell's criterion in order to repeatedly locate the model; obtaining the model, the model being provided with a number of v-grooves; securing the model on the kinematic mount of the thermoforming nest by using said number of v-grooves to engage corresponding pins of the plurality of pins of the kinematic mount; and placing the first material on the model and thermoforming said first material around the model and the plurality of pins such that a negative of the model and the plurality of pins is formed in the first material, wherein the flexure is connected to an alignment pin of the corresponding pins, the alignment ping being movable and moving jointly with the flexure such that when one v-groove of the model engages the movable pin, the flexure moves with spring resistance to motion, in order to accommodate any size of the model that is between a defined minimum and maximum size.

### BRIEF DESCRIPTION OF THE DRAWINGS

To easily identify the discussion of any particular element or act, the most significant digit or digits in a reference number refer to the figure number in which that element is first introduced. Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1A illustrates the degrees of freedom of movement of a body in accordance with one embodiment.

FIG. 1B illustrates a coupling in accordance with one embodiment.

FIG. 1C illustrates a coupling in accordance with one embodiment.

FIG. 2 depicts a top view of a thermoforming nest in accordance with one embodiment.

FIG. 3A depicts a perspective view of a thermoforming nest in accordance with one embodiment.

FIG. 3B depicts a perspective view of a nest in accordance with one embodiment.

FIG. 3C depicts a perspective view of a nest in accordance with one embodiment

FIG. 4 depicts a perspective view of a thermoforming nest in accordance with one embodiment.

FIG. 5 depicts a perspective view of another thermoforming nest in accordance with one embodiment.

FIG. 6 depicts a bottom view of a cross section of a thermoforming nest in accordance with one embodiment.

FIG. 7 depicts a top view of a cross section of a thermoforming nest in accordance with one embodiment.

FIG. 8A depicts a flexure in a first position in accordance with one embodiment.

FIG. 8B depicts a flexure in another position in accordance with one embodiment.

FIG. 9 depicts a method in accordance with one embodiment.

FIG. 10 depicts a computer system in accordance with one embodiment.

### DETAILED DESCRIPTION

The illustrative embodiments described herein are directed to a nest having a plurality of pins and corresponding engaging surfaces that conform to Maxwell's criterion and a flexure that jointly moves with one of the pins in order to secure and locate several size of models in a repeatable manner for a manufacturing process. One or more embodiments recognize that an existing problem in manufacturing is the need for locating objects such as three-dimensional (3D) printed models repeatedly. One or more embodiments are directed to the use of kinematics to determine positions for pins in a thermoforming nest, said pins being configured to hold different sizes of 3D printed models and a thermoformed material for repeatability.

In an embodiment, one pin is connected to, and moves with a flexure that is designed to extend and contract to a maximum position and a minimum position in order to secure a maximum size and a minimum size of the model respectively. In another embodiment, the model is a model of a dental jaw, but can be any model on which a material having a substantially constant thickness is to be thermoformed. In an embodiment, an operator loads a model onto a kinematic mount of a thermoforming nest, the kinematic mount comprising at least the plurality of pins. The mount may be a part of the nest or may be the nest. The model is provided with a plurality of v-grooves that engage a number of the pins. A flexure connected to one of the pins and moving jointly with said pin is able to extend or contract in a defined degree of freedom (DOF) in order to secure the model.

Flexures allow motion through the bending elements that make up the flexure. The design of elements of the flexure ensures compliance of movements of the flexure in its degree(s) of freedom, but make the flexure relatively stiff in its degree(s) of constraint (DOC) thus allowing the provision of motion in defined directions, but constraint in other directions. Friction-less, controlled, limited-range motion is thus achieved. Designing flexures involves developing a model, using Finite Element Analysis (FEA), and verifying the model. By identifying and characterizing desired degrees of freedom/directions of travel, a flexure topology can be generated. For example, a computer can be used to iteratively synthesize the topology of a flexure by satisfying displacement and force requirements of the flexure. In another example that uses flexural building blocks, flexural elements with intersecting lines of action are designed to form a center about which a stage rotates.

In an illustrative embodiment, a flexure 602 is designed with flexure element 604 to have linear travel with a spring resistance to motion which acts as a self-centering feature for the flexure 602. By integrating movable pin 202a with the flexure 602, the movable pin is translatable to accommodate different sizes of a model 206.

Movable pin 202a is part of a plurality of pins that conform to Maxwell's criterion as described hereinafter. A plurality of pins conforming to Maxwell's criterion allows the creation of a quasi-Maxwell kinematic coupling, which is also described hereinafter.

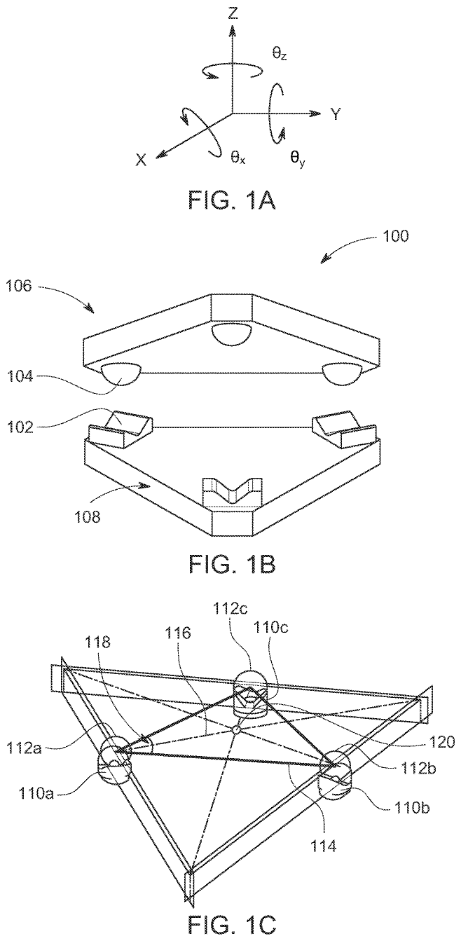

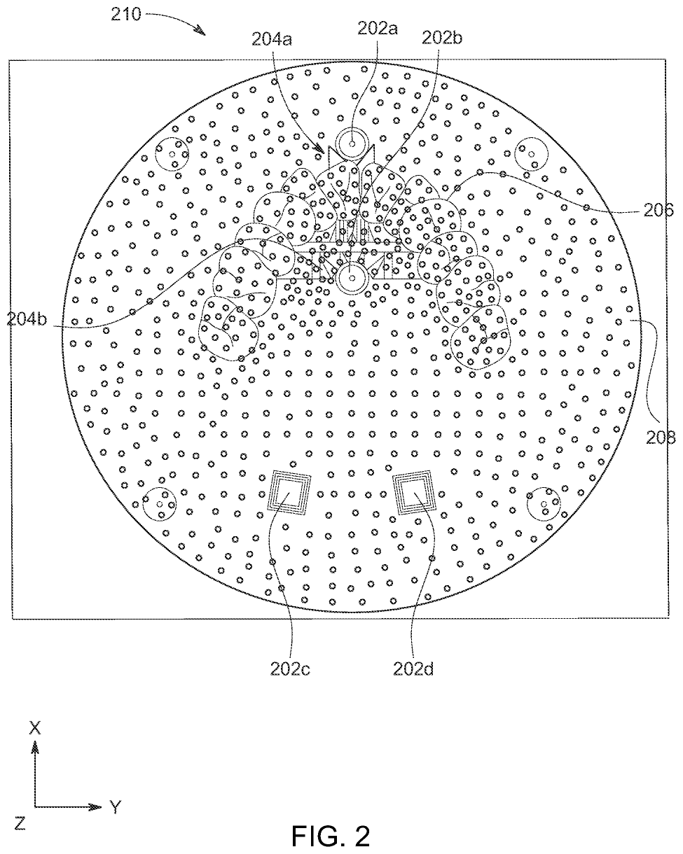

Kinematics is a field of classical mechanics that encompasses describing the motion of objects. An aspect thereof, kinematic coupling, involves the coupling of systems together to provide precision and certainty of location. The reproducibility and precision of a kinematic coupling comes from the principle of exact constraint design which requires that the number of points of constraint should be equal to the number of degrees of freedom to be constrained. As shown in FIG. 1A, every rigid body has six degrees of freedom: three for translation (X, Y, Z) and three for rotation (θ_{X}, θ_{Y}, θ_{Z}). By making contact with a number of points equal to the number of degrees of freedom that are to be restrained, a predictable kinematic coupling is obtained.

Maxwell kinematic couplings (or kinematic mounts designed with the Maxwell Criteria) utilize some form of an arrangement of three balls in three V-grooves to locate and position a pair of parallel plates such that six degrees of freedom are held fixed.

As shown in FIG. 1B, Maxwell kinematic coupling 100 has three radial v-grooves 102, oriented to the center of the bottom plate 108 that mate with three hemispheres 104 in a top plate 106. Each hemisphere 104 has two contact points for a total of six contact points, enough to exactly constrain to top plate 106 relative to the bottom plate 108 (constrain all five of the top plate's degrees of freedom. The sixth degree of freedom (Z) will be constrained by gravity or by an external clamping method (ex. Bolt through top plate into threads in bottom plate.)). The Maxwell kinematic coupling 100 follows the Maxwell's criterion which generally requires that to promote stability, bearing surfaces should be arranged such that, if one surface is removed, the direction in which the part would then be free to move is as close to perpendicular to that surface as possible.

The Maxwell kinematic coupling 100 can thus precisely locate critical parts to critical surfaces in a repeatable manner and eliminate or substantially eliminate error due to slop or movement.

It follows then that, in the case of a planar mount coupling, a layout of 3 arbitrary v-grooves (arbitrary v-groove 110a, arbitrary v-groove 110b and arbitrary v-groove 110c), as shown in FIG. 1C, can be optimized for stability and repeatability by defining a triangle 114 having a corner at the center of each arbitrary ball (arbitrary ball 112a, arbitrary ball 112b, arbitrary ball 112c) and orienting each of the arbitrary v-grooves such that the center line 116 of each arbitrary v-groove (line parallel to bottom of v-groove) bisects the corresponding apex angle 118. The three center lines will thus intersect at the centroid 120 of the coupling and the combination of the grooves in the arrangement satisfying Maxwell's criterion offers stability and repeatability.

### Kinematic Apparatus

In an illustrative embodiment, as shown in FIG. 2, three pins (movable pin 202a, pin 202c and pin 202d) are initially arranged on a kinematic nest which is in this case a thermoforming nest 210 to satisfy the Maxwell's criterion. A fourth pin 202b is added to form a purposefully over-constrained coupling hereinafter referred to as quasi Maxwell kinematic coupling that still follows Maxwell's criterion. The over-constraining helps align and secure different sizes of the model 206. Pin 202c and pin 202d have a generally rectangular shape with sloping sidewalls. This shape is configured to receive an external clamping means and a thermoforming disc 208 and generate sloping sidewalls in the thermoformed disc 208 in order to create pockets in the thermoformed disc 208 having slanting surfaces. The slanting surfaces allow for easy removal of the thermoformed disc 208 with the model from the nest. Moreover pins 202c and 202d have their orthogonals staying inside the triangle 114, i.e. they point to movable pin 202a and the long edges are parallel to lines running between 202c to 202a and between 202d to 202a. Model 206 has two sideways v-grooves (sideways v-groove 204a and sideways v-groove 204b) to engage movable pin 202a and pin 202b respectively. Therefore, surfaces of the four pins, the two sideways v-grooves (at 202a and 202b) and negative rectangular shapes (at 202c and 202d) are arranged to provide a satisfaction of Maxwell's criterion, thus offering stability and repeatability down the manufacturing line. The negative shape formed at 202b is redundant and over-constrained and is used or not-used as needed in subsequent manufacturing steps in the manufacturing line Of course, other arrangements that conform to Maxwell's criterion can be obtained in light of this specification. The examples in this disclosure are used only for the clarity of the description and are not limiting to the illustrative embodiments. Additional operations, actions, tasks, activities, and manipulations will be conceivable from this disclosure and the same are contemplated within the scope of the illustrative embodiments.

As shown in FIG. 2, model 206 can be any model such as a model of a dental arch that is used in an aligner fabrication process. The aligner fabrication process begins by taking an impression in a dental office. The impression is scanned and digitized to create a virtual treatment plan. A model for each of the stages of the treatment plan is built. One treatment plan can have a plurality of models, for example, forty models. Each model of the plurality of models represents a different stage of the teeth of the patient in a gradual tooth straightening procedure. A material such as a polymer material is thermoformed over each model. The newly formed aligners are then obtained and trimmed to specification using, for example, a Computer Numerical Control (CNC) machine, along a gum-line of the model or patient. The aligners are then polished and packaged to ensure that the aligners are in the correct sequence as dictated by the treatment plan.

The illustrative embodiments recognize that, throughout the manufacturing process, the location of each model and aligner is to be known. For example, in an automated manufacturing process, aligners are repeatedly picked up by a robot arm from an assembly line for trimming. Being able to locate the aligners and the models in a repeatable manner is thus critical for the manufacturing process. For example, a conveyor system may be configured to move the plurality of assemblies in a stepwise movement sequence from a loading area to the heating system, then from the heating system to the forming system, and then from the forming system to an unloading area.

The illustrative embodiments also recognize that there are dimensional tolerances/accuracy issues inherent in 3D printing as well as other printing processes. An error, such as deviations of a printed model from base dimensions can be propagated in the printing of other models in a treatment plan, thus quickly adding up. Such errors in dimensions, if unaccounted for can prevent the models from fitting or being secured in a desired location due to the dimensions being too large or too small with respect to the desired location. Moreover, the more accurately the manufacturing process locates parts of the model, the less work needed downstream to correct errors caused by improper locating.

In an embodiment, dental model (model 206) and aligner (thermoforming disc 208) are constrained and repeatedly located by ensuring that the pins and corresponding engaging surfaces conform to Maxwell's criterion.

Dimensional differences between sideways v-grooves of one model and sideways v-grooves of another model of the same entity/patient are also accounted for by employing a flexure 602 configured to move jointly with movable pin 202a from an initial position to a final position in order to secure a minimum size of the model 206 and a maximum size of the model 206 respectively.

Further, dimensional differences between sideways v-grooves of one model and sideways v-grooves of another model of a different entity (such as an adult patient's dental arch model and a child patient's dental arch model) are accounted for by employing a flexure 602 configured to move jointly with movable pin 202a from an initial position to a final position in order to secure a minimum size of the model 206 and a maximum size of the model 206 respectively.

Thus, in order to minimize unwanted movement (ie: slop), avoid the consequential loss of positional alignment and to accommodate the part tolerance error of models on a thermoforming nest, a set of kinematic alignment features and a spring flexure are configured, embedded in the nest, to move the model back to a known and repeatable location that could be used by down-stream automation equipment. To achieve this, a quasi-Maxwell kinematic coupling is used to locate the model with a spring flexure embedded in the locating nest to accommodate the positional misalignment inherent in manufacturing large quantities of models and thermoformed parts. This provides a simple design with one moving part, passively returning the model 206 to a repeatable position on the nest without external mechanisms and with near-zero frictional effects and offering low cost of production and cost of ownership.

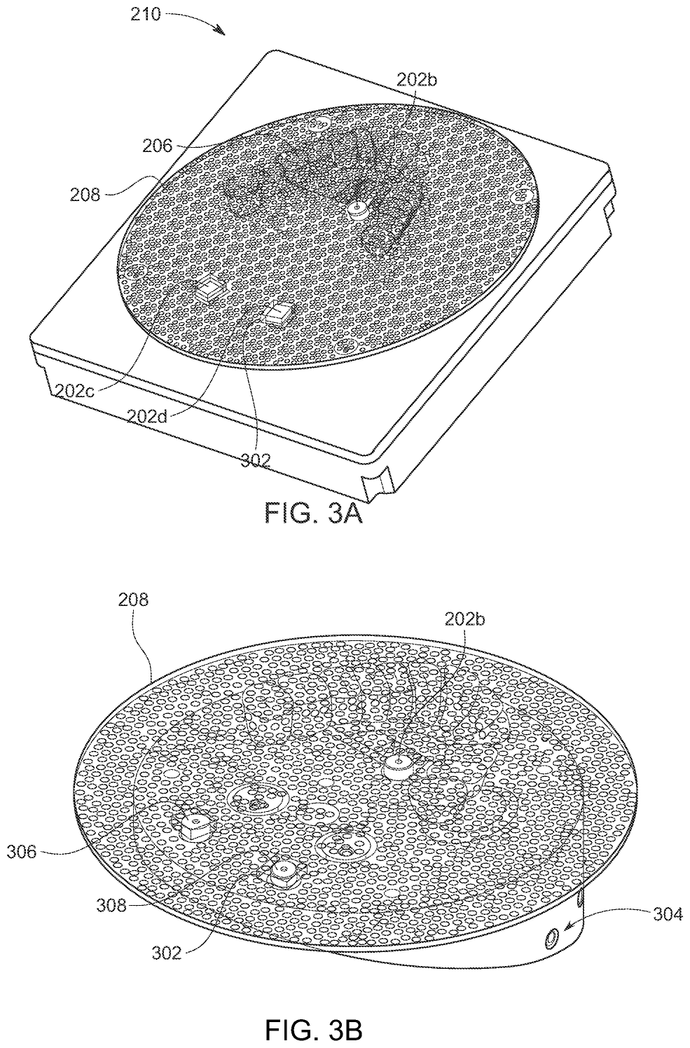

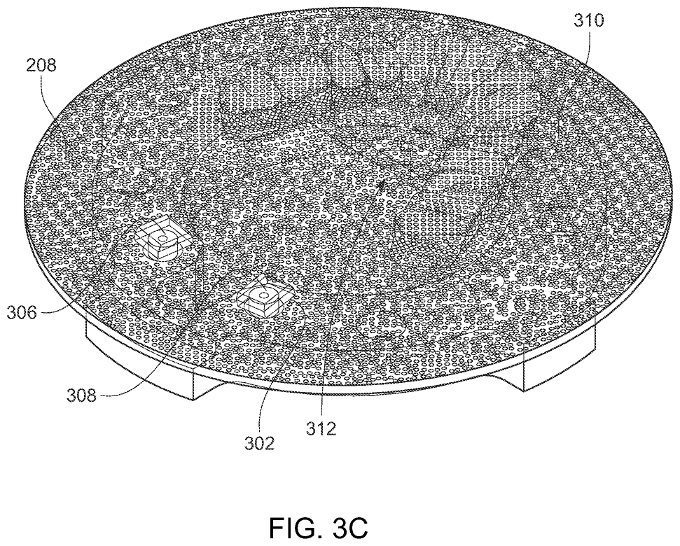

FIG. 3A shows a perspective view of the thermoforming nest 210 showing the negative shapes in thermoforming disc 302 corresponding to pins 202c and 202d after the polymer material has been thermoformed on the model 206. The thermoforming nest 210 has two round pins to engage the sideways V-grooves printed in the model 206 to locate the model during the thermoforming process. The thermoforming nest 210 also has two more rectangular pedestals (pins 202c and 202d) which are, for example, machined into the base of the thermoforming nest 210. Pins 202c and 202d produce matching negative shapes in thermoforming disc. For pins 202c and 202d these are rectangular shaped pockets having slanting or partially slanting walls. The negative shapes in thermoforming disc 302 are used for downstream purposes as described hereinafter.

FIG. 3B shows a perspective view of a second nest 304 that is used, for example, in a downstream step of the manufacturing process. After thermoforming is complete, disk 208 that has the model 206 embedded in the thermoformed disc 208 as well the molded round shapes from pins 202a and 202b as well as the negative shapes of pins 202c and 202d. The thermoformed disc 201 may transferred to the second nest 304 (such as a nest in a robot workcell). This may be done for a number of reasons, including transferring it to be laser-marked and CNC cut. To do those operations, the disc 208 with the model 206 has to be located accurately again and this can be achieved by using pockets in the thermoformed disc 208 corresponding to pins 202a and 202b as well as the rectangular pockets corresponding to pins 202b and 202d. The four pockets re-engage a set of pins (e.g. 4¼ in OD round pins), including a first and second round pins 306 and 308 respectively on the second nest 304 as shown in FIG. 3B. In other words, three pins are needed to create the modified-kinematic mount (movable pin 202a, pin 202c and pin 202d). Pin 202b is introduced to over-constrain the disc 208 which over-constraining can be tolerated because it helps hold the center of the model, as shown in FIG. 3B, during certain operations such as CNC cut operations, which can be a quite aggressive/unstable operations. Of course, pin 202b can be eliminated when not needed. First round pin 306 and second round pin 308 engage the walls of the rectangular pockets that were formed in the thermoforming step. The second nest 304 may or may not have an upper plate/clamping means. In an embodiment in which there is no upper plate, gravity may act to confine a secured model in the sixth degree of freedom (Z-direction). In an illustrative embodiment, the second nest 304 may also utilize vacuum suction cups to secure model in the sixth degree of freedom (Z-direction). When vacuum is applied to the suction cups and the model is in close proximity and in the process of being located/aligned by pins 306, 308 and 202b, the model is drawn down and against the surface of second nest 304. In an example, 4 round pins (306, 308, 202b and 202a) along with 5 vacuum suction cups embedded in the face of the second 304 nest are used. A computer turns on a vacuum to those suction cups when a robot is attempting to place the model on the second nest 304 and on the pins. The vacuum provides control of that last degree of freedom, Z.

FIG. 3C shows a third nest 310 (such as a laser mark nest) used in a downstream process. It may be employed for a laser marking step. The laser mark nest may rely on the same alignment & part locating principles as the upstream thermoforming nests.

The main difference between a CNC nest the laser mark nest is that the laser mark nest may not include pin 202b. The laser mark nest may require the use of a backlight that shines from below and behind the nest 310 and up through the thermoformed disk 208 so that a camera (not shown) located above the nest 310 and looking down onto the disk 208, can image and capture a 2D data matrix code that is laser printed on the disk 208. To make room for that backlight, it may be necessary to remove/eliminate pin 202b (leaving an unoccupied position 312) as it would simply block the light and interfere with ability for the camera to read a code on the part (for example, a code required to track the part through the robot cell and downstream processes). Critical locating features (pins 202a, 202c and 202d) are still maintained. These 3 pins still obey the Maxwell criteria and quasi-Maxwell kinematic coupling. Further, the locating precision, repeatability and accuracy requirements of the laser marking may be much lower than that required at, say, the CNC mill nest. Therefore, a relatively small loss in precision is not detrimental to the laser marking process.

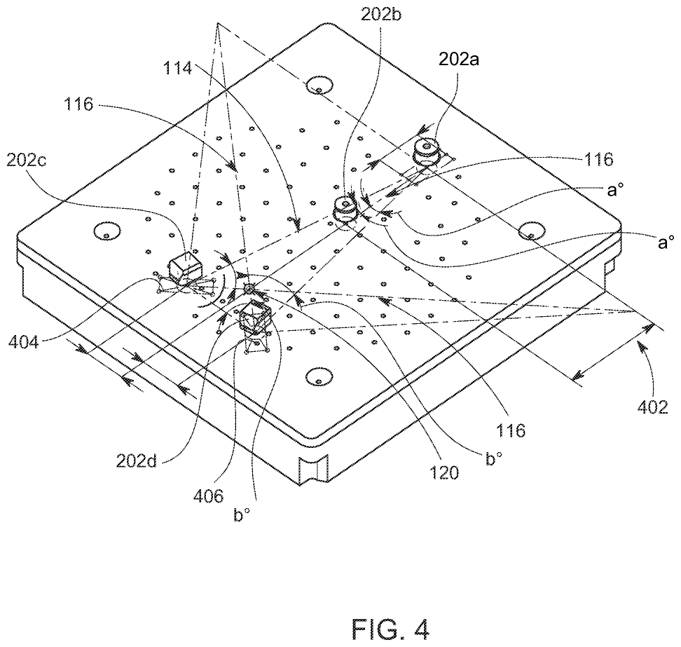

FIG. 4 shows a perspective view of the thermoforming nest 210 wherein the pins are arranged to provide conformity to Maxwell's criterion. Movable pin 202a, pin 202c and pin 202d form a triangle 114. Center lines 116 of movable pin 202a, pin 202c and pin 202d intersect at the centroid 120. In order to tightly secure a model 206 on the thermoforming nest 210, pin 202b is disposed at a defined distance 402 below the movable pin 202a in order to receive a sideways v-groove 204b of the model 206 to constrain and secure the model tightly. Said thermoforming nest 210 can receive a thermoforming disc for it to be thermoformed on the model 206. FIG. 4 also shows pins 202c and 202d disposed at positions 404 and 406 corresponding to positions of the first and second round pins 306 and 308 of FIG. 3B respectively. It can be seen that the centroid 120 acts along center line 116 of pin 202a. An equilateral triangle can't always be preserved and used an as such a compromise of the geometry can be made to fit a particular application. For example, a compromise can be made for the quasi kinematic mount wherein because of the use of rectangular pedestals to form the pockets at 202c & 202d the geometry can be rotated the to preserve the centroidal line of action/center line 116 shown passing through pin 202a.

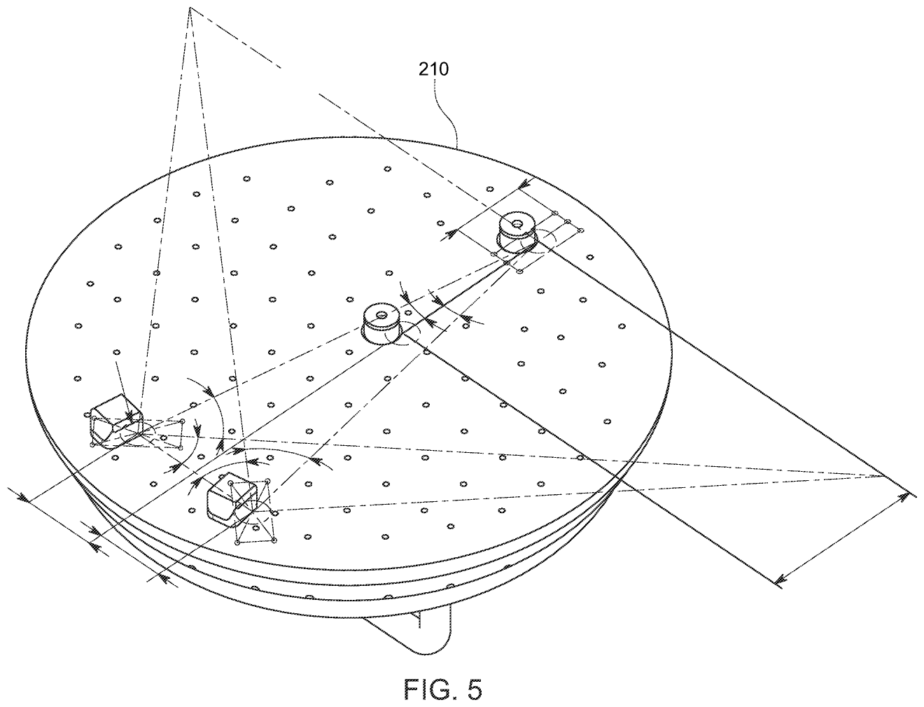

FIG. 5 shows a different shape of thermoforming nest 210. Said shape can be used in, for example, a manual thermoforming process to repeatedly locate and confined model 206

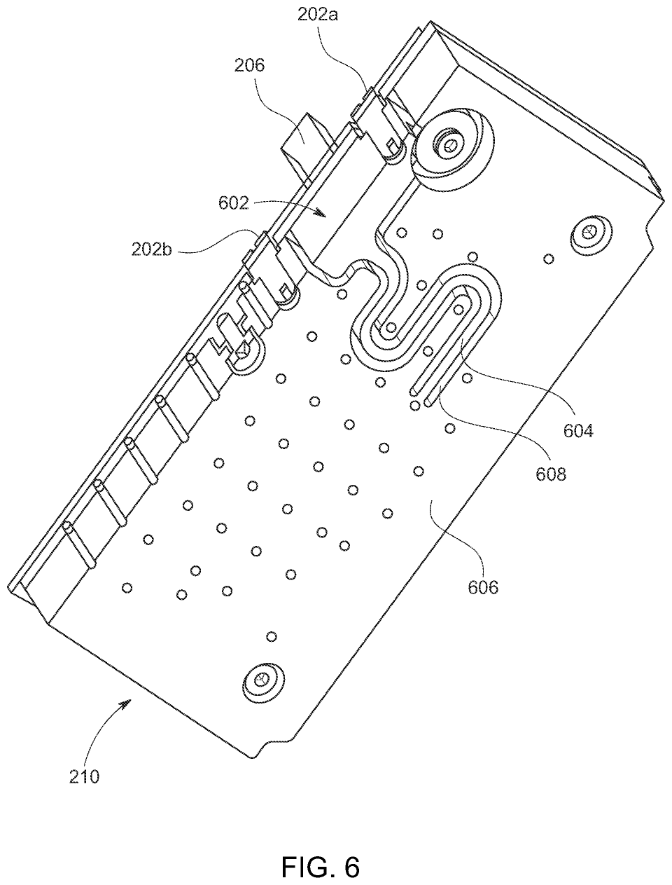

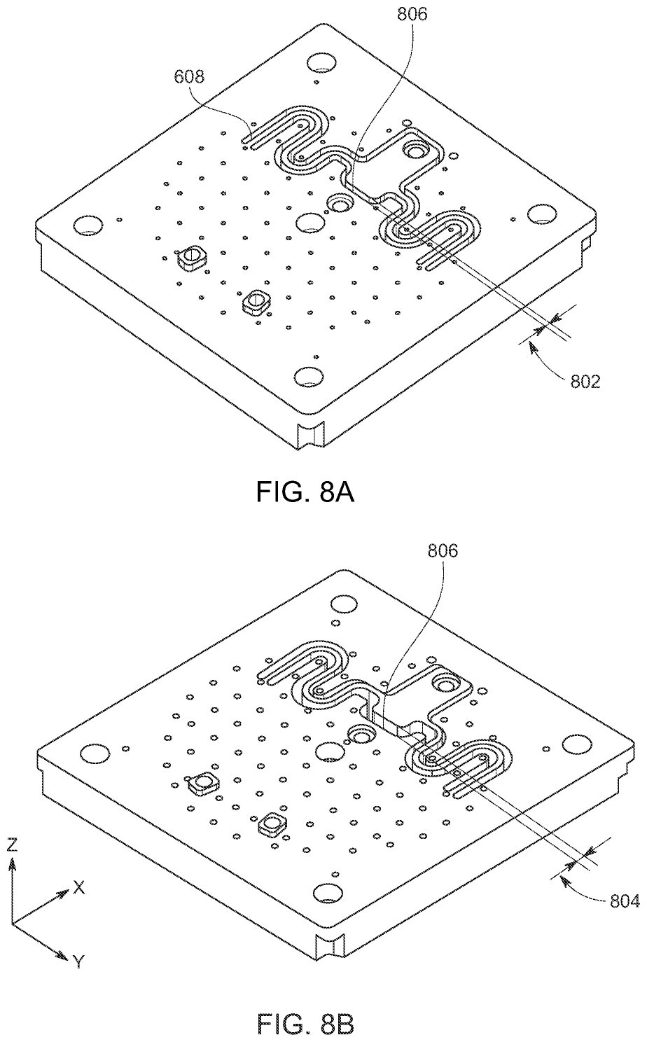

Turning now to FIG. 6, a cross section of a thermoforming nest 210 depicting the flexure 602 is shown. The flexure 602 is configured to have flexible or spring-like flexure elements 604 engineered to be compliant in the X-direction of FIG. 2 and yet stiff in the Y and Z directions while returning to a nominal ‘home’ (FIG. 8A) position repeatedly with minimum error and extremely low friction. The flexure 602 provides provide compliance in the thermoforming nest 210 in order to secure different sizes of the model 206. The thermoforming nest 210 can thus precisely locate the model 206 in a repeatable manner so that further actions can be taken on the model 206, avoiding much more costly or complicated approaches. The flexure 602 is configured to offer extremely low hysteresis and nearly zero friction due to its inherent use of bending and/or torsional flexure elements 604 rather than the surface interaction of multiple parts such as rotary bearings or sliding surfaces. Flexure 602 therefore provides near-infinite life presuming design loads are not exceeded compared to more traditional methods and mechanisms that have lifetimes measured as low as thousands of cycles of use.

In an illustrative embodiment showing the interaction between the quasi Maxwell kinematic coupling and the flexure 602, a V-groove geometry pair is molded (i.e. 3D printed) into model 206 to which a matching pair of ¼″ outside diameter (OD) alignment pins mates and locates the arch. One of the pins, pin 202b is stationary on the nest. The second pin, movable pin 202a is attached to the flexure 602, the flexure 602 being cut from the nest base plate 606, and permitting the movable pin 202a to be displaced in the X direction (FIG. 8B) a distance equal to or less than a maximum distance during arch loading and then spring back to the ‘origin’ (FIG. 8A) thereby moving the arch back to a repeatable position passively without the use of any external mechanism. Because a flexure approach is used and the permitted displacement and maximum flexural loads calculated via FEA, the flexure offers near life-time usage as opposed to the use of a regular spring mechanism that would have a short and definite life (i.e. months), producing the very repeatable movement back to a center position (i.e. origin).

The pair of ¼″ OD alignment pins are press-fit into the nest base plate 606. The nest base plate 606 includes a feature cut with CNC or Electrical Discharge Machining (EDM) that removes material from the nest base plate 606 such that what remains is a moving spring-like flexure element 604 within a part to which the top alignment pin (movable pin 202a) is attached. The thickness of the flexure 602 is designed to permit a defined but small amount (such as 1-3 mm) of movement in the X-direction and thereby a matching amount of movement by the movable pin 202a. The variance or slop being accommodated are in the distance between the V grooves that are print in the models. The 3D printing process from in the model (e.g. from arch to arch of a 3d dental model) produces small errors in the X direction in the range of, for example, ˜0.010 mm to 0.500 mm. The design of the flexure may take into consideration dimensional restrictions of the nest. The flexure may be designed to be large enough to press-fit in the movable pin 201a as well as strong enough to survive strong forces of the thermoforming process. Moreover, it may be designed to be “soft” enough to move even with 0.1 lbf (load force) applied at movable pin 202a. Also it may be designed such that X displacement in millimeters that movable pin 202a would move with a defined load force applied (such as 1 lbf) is enough to accommodate the ‘slop’ (ie the variance in the 3D printed sideways V-groves. If the distance between pins 202a and 202b is too short, the model 206 will float around on the nest 210 and possibly fall off. If that distance is too large, the arch may chip/crack during insertion or may pop out all together. The flexure compensates for that relatively large variation. Because the distance between the alignment pins (pin 202b and movable pin 202a) is configured to match the V groove features in model 206, the movable pin 202a will displace during model 206 loading on the nest base. For any out of tolerance V groove location and/or mis-location of the alignment pin locations, the flexure will self-center and self-locate the arch, retaining the arch securely during subsequent manufacturing operations. Utilizing the set of four pins arranged to provide conformity to the Maxwell criterion produces matching pockets in the thermoforming disc 208 during the thermoforming process.

The remaining slit 608 or groove left after machining is also selected to act as a self-limiting ‘bump stop’ preventing the flexure 602 from being overextended or damaged during regular usage of the nest, thereby providing the near-infinite life.

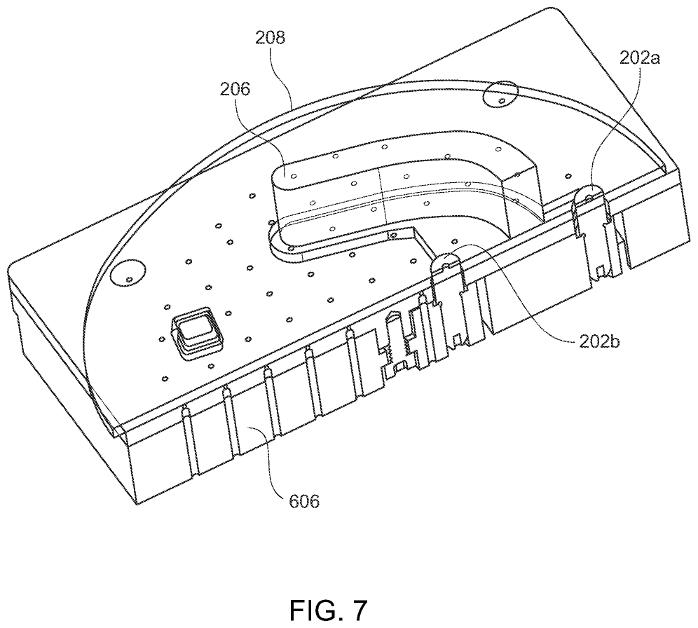

FIG. 7 shows a top view of a cross section of the thermoforming nest 210 detailing how the pins fit into the nest base plate 606.

In FIG. 8A, the flexure 602 is shown in its origin position. The flexure 602 is at a first distance 802 from a first edge 806 of the slit 608.

In FIG. 8B, the flexure 602 is shown in a maximum position wherein it is at a second distance 804 from the first edge 806 of the slit 608. An original position and a maximum displacement (distance 804-distance 802) can therefore be configured to accommodate a minimum and a maximum size of the model 206 respectively.

### Method

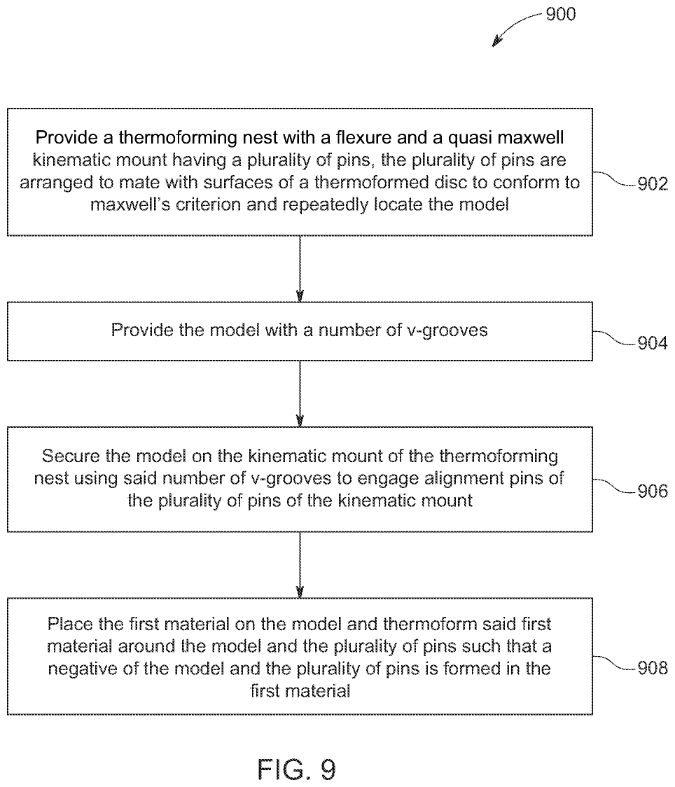

FIG. 9 shows a method according to an illustrative embodiment. In step 902, process 900 provides a thermoforming nest with a flexure 602 and a quasi-Maxwell kinematic mount having a plurality of pins, the plurality of pins is arranged to conform to Maxwell's criterion and repeatedly locate the model. In step 904, process 900 provides the model with a plurality of v-grooves. In an illustrative embodiment, the model 206 has two v-grooves. The flexure 602 is connected to the movable pin 202a and moves jointly with the pin such that when one v groove of the model engages the pin that is connected to the flexure, the flexure moves to accommodate any size of the model that is between a defined minimum and maximum size in order to secure the model.

In step 906, process 900 secures the model on the quasi Maxwell kinematic mount of the thermoforming nest such that the v-grooves engage corresponding pins of the plurality of pins. The pins are the alignment pins (pin 202b and movable pin 202a). In step 908, process 900 places the first material on the model and thermoforms the first material around the model and the plurality of pins such that the a negative of the model and the plurality of pins is formed in the first material. In an illustrative embodiment, the first material is a polymer and the model 206 is a dental arch model. This allows the thermoforming of an aligner on the dental arch model.

In an alternative embodiment, a fixed pair of alignment pins is used to provide arch alignment of the model. Spacing between the alignment pins is this chosen to allow a size of a model 206 to be loaded and may useable for models of that size. In another alternative embodiment, one fixed pin and one pin attached to a coiled-spring return mechanism (not shown) are designed to produce similar results as the flexure 602 but with a defined and shorter life due ease of exceeded acceptable yield strengths. In yet another alternative embodiment, active mechanisms having external air cylinders or electrical servo motors can be used to move alignment pins and align a model on a nest. This requires moving parts, pre-alignment and tuning during build and could be more expensive.

### Computer System

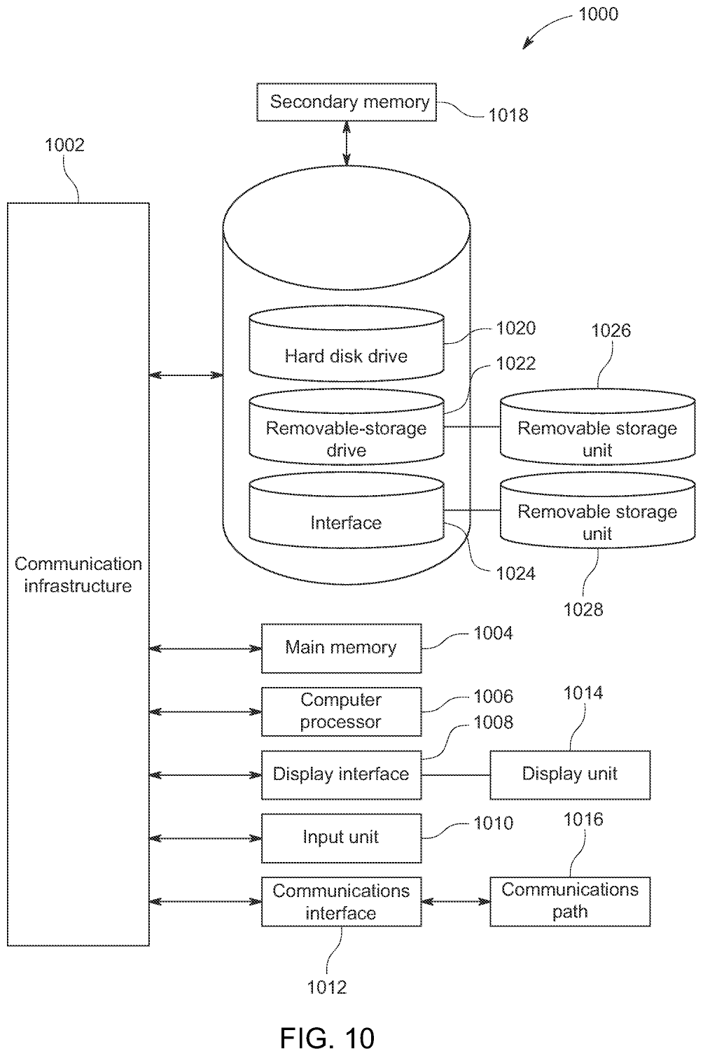

Having described the kinematic apparatus, reference will now be made to FIG. 10, which shows a block diagram of a computer system 1000 that may be employed in accordance with at least some of the illustrative embodiments herein. Although various embodiments may be described herein in terms of this exemplary computer system 1000, after reading this description, it may become apparent to a person skilled in the relevant art(s) how to implement the disclosure using other computer systems and/or architectures.

In one example embodiment herein, at least some components of the kinematic apparatus may form or be included in the computer system 1000 of FIG. 10. The computer system 1000 includes at least one computer processor 1006. The computer processor 1006 may include, for example, a central processing unit (CPU), a multiple processing unit, an application-specific integrated circuit (“ASIC”), a field programmable gate array (“FPGA”), or the like. The computer processor 1006 may be connected to a communication infrastructure 1002 (e.g. a communications bus, a cross-over bar device, a network). In an illustrative embodiment herein, the computer processor 1006 includes a CPU that that controls the thermoforming process, including securing the model 206 on the quasi Maxwell kinematic mount, placing the first material on the model 206 for thermoforming and repeatedly aligning the model 206 and thermoformed disc relative to a defined reference position for automated stepwise manufacturing.

The display interface 1008 (or other output interface) forwards text, video graphics, and other data from the communication infrastructure 1002 (or from a frame buffer (not shown)) for display on display unit 1014. For example, the display interface 1008 may include a video card with a graphics processing unit or may provide an operator with an interface for controlling the kinematic apparatus.

The computer system 1000 may also include an input unit 1010 that may be used, along with the display unit 1014 by an operator of the computer system 1000 to send information to the computer processor 1006. The input unit 1010 may include a keyboard and/or touchscreen monitor. In one example, the display unit 1014, the input unit 1010, and the computer processor 1006 may collectively form a user interface.

One or more steps of aligning and locating a model or thermoformed disc may be stored on a non-transitory storage device in the form of computer-readable program instructions. To execute a procedure, the computer processor 1006 loads the appropriate instructions, as stored on storage device, into memory and then executes the loaded instructions.

The computer system 1000 may further comprise a main memory 1004, which may be a random-access memory (“RAM”), and also may include a secondary memory 1018. The secondary memory 1018 may include, for example, a hard disk drive 1020 and/or a removable-storage drive 1022 (e.g., a floppy disk drive, a magnetic tape drive, an optical disk drive, a flash memory drive, and the like). The removable-storage drive 1022 reads from and/or writes to a removable storage unit 1026 in a well-known manner. The removable storage unit 1026 may be, for example, a floppy disk, a magnetic tape, an optical disk, a flash memory device, and the like, which may be written to and read from by the removable-storage drive 1022. The removable storage unit 1026 may include a non-transitory computer-readable storage medium storing computer-executable software instructions and/or data.

In further illustrative embodiments, the secondary memory 1018 may include other computer-readable media storing computer-executable programs or other instructions to be loaded into the computer system 1000. Such devices may include removable storage unit 1028 and an interface 1024 (e.g., a program cartridge and a cartridge interface); a removable memory chip (e.g., an erasable programmable read-only memory (“EPROM”) or a programmable read-only memory (“PROM”)) and an associated memory socket; and other removable storage units 1028 and interfaces 1024 that allow software and data to be transferred from the removable storage unit 1028 to other parts of the computer system 1000.

The computer system 1000 may also include a communications interface 1012 that enables software and data to be transferred between the computer system 1000 and external devices. Such an interface may include a modem, a network interface (e.g., an Ethernet card or an IEEE 802.11 wireless LAN interface), a communications port (e.g., a Universal Serial Bus (“USB”) port or a FireWire® port), a Personal Computer Memory Card International Association (“PCMCIA”) interface, Bluetooth®, and the like. Software and data transferred via the communications interface 1012 may be in the form of signals, which may be electronic, electromagnetic, optical or another type of signal that may be capable of being transmitted and/or received by the communications interface 1012. Signals may be provided to the communications interface 1012 via a communications path 1016 (e.g., a channel). The communications path 1016 carries signals and may be implemented using wire or cable, fiber optics, a telephone line, a cellular link, a radiofrequency (“RF”) link, or the like. The communications interface 1012 may be used to transfer software or data or other information between the computer system 1000 and a remote server or cloud-based storage (not shown).

One or more computer programs or computer control logic may be stored in the main memory 1004 and/or the secondary memory 1018. The computer programs may also be received via the communications interface 1012. The computer programs include computer-executable instructions which, when executed by the computer processor 1006, cause the computer system 1000 to perform the methods as described hereinafter. Accordingly, the computer programs may control the computer system 1000 and other components of the kinematic apparatus.

In another embodiment, the software may be stored in a non-transitory computer-readable storage medium and loaded into the main memory 1004 and/or the secondary memory 1018 of the using the removable-storage drive 1022, hard disk drive 1020, and/or the communications interface 1012. Control logic (software), when executed by the computer processor 1006, causes the computer system 1000, and more generally the kinematic apparatus, to perform the some or all of the methods described herein.

Lastly, in another example embodiment hardware components such as ASICs, FPGAs, and the like, may be used to carry out the functionality described herein. Implementation of such a hardware arrangement so as to perform the functions described herein will be apparent to persons skilled in the relevant art(s) in view of this description.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiment or enumerated variation. Many modifications, variations and other embodiments will come to the minds of those skilled in the art, in view of this specification, and are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

1. A kinematic apparatus comprising:
a nest;
a plurality of pins arranged in the nest to provide conformity to Maxwell's criterion when coupled with corresponding engaging surfaces, in order to repeatedly locate a model;
a flexure embedded in the thermoforming nest and connected to an alignment pin of the plurality of pins that is movable, the flexure is configured to move jointly with the alignment pin that is movable;
wherein another alignment pin of the plurality of pins is embedded in the thermoforming nest, is stationary, and engages a first groove of the model,
wherein the alignment pin that is movable is configured to engage a second groove of the model and move jointly with the flexure which uses a spring resistance to motion to secure the model on the mount.

2. The kinematic apparatus of claim 1, wherein the nest is a thermoforming nest or a Computer Numerical Control (CNC) nest or a laser mark nest.

3. The kinematic apparatus of claim 1, wherein the kinematic apparatus is a thermoforming apparatus and the plurality of pins are four and include two other pins that have a substantially rectangular shape.

4. The kinematic apparatus of claim 1, wherein the thermoforming nest is configured to receive a 3D printed dental arch model in order to thermoform an aligner on the 3D printed dental arch model.

5. The kinematic apparatus of claim 1, wherein the flexure is movable in the X direction and unmovable in the Y and Z directions.

6. The kinematic apparatus of claim 1, wherein the flexure is movable from an original position to a maximum position in order to secure any model size that is between a minimum and a maximum size respectively.

7. The kinematic apparatus of claim 6, wherein a thickness of the flexure is designed to produce a slit in the thermoforming nest, wherein in the original position, the flexure is a first distance from a first edge of the slit and in the maximum position, the flexure is a second distance from the first edge of the slit, wherein a difference between the first and second distances is chosen to accommodate tolerances of the model.

8. The kinematic apparatus of claim 2, wherein the first and second grooves are sideways v-grooves and the mount is over constrained in the thermoforming nest or not over-constrained in the CNC and laser mark nests.

9. The kinematic apparatus of claim 1, wherein a thermoforming disc under pressure from a clamping device is thermoformed around the model, the thermoforming disc being made of a polymer material having a substantially constant thickness.

10. A method, comprising:
providing a nest with a flexure and a plurality of pins, the plurality of pins are arranged to mate with corresponding surfaces to conform to Maxwell's criterion in order to repeatedly locate the model;
providing the model with a number of v-grooves;
securing the model on the nest by using said number of v-grooves to engage corresponding pins of the plurality of pins of the nest; and,
performing a manufacturing step on the model;
wherein the flexure is connected to an alignment pin of the corresponding pins, the alignment pin being movable and moving jointly with the flexure such that when one v-groove of the model engages the movable pin, the flexure moves with spring resi stance to motion, in order to accommodate any size of the model that is between a defined minimum and maximum size.

11. The method of claim 10, wherein the manufacturing step includes placing a first material on the model and thermoforming said first material around the model and the plurality of pins such that a negative of the model and the plurality of pins is formed in the first material.

12. The method of claim 11, wherein the manufacturing step includes performing CNC cutting of the first material or laser marking of the first material.

13. The method of claim 11, wherein the model is a 3D printed dental arch model.

14. The method of claim 13, wherein the first material that is thermoformed, together with the dental arch model in the thermoforming nest forms a quasi-Maxwell kinematic coupling which is subsequently obtained by an external device and repeatedly located relative to a reference point.

15. The method of claim 14, further comprising trimming the first material that is thermoformed on the dental arch model along a gum line of the dental arch model to produce an aligner.

16. The method of claim 15, wherein the providing, securing and placing are repeatable to produce a plurality of other aligners from a corresponding plurality of other dental arch models using the same thermoforming nest.

17. A computer system comprising at least one processor operable to perform the steps of:
obtaining a nest provided with a flexure and a plurality of pins, the plurality of pins are arranged to mate with corresponding surfaces to conform to Maxwell's criterion in order to repeatedly locate the model;
obtaining the model, the model being provided with a number of v-grooves;
securing the model on the nest by using said number of v-grooves to engage corresponding pins of the plurality of pins of the nest; and,
performing a manufacturing step on the model;
wherein the flexure is connected to an alignment pin of the corresponding pins, the alignment ping being movable and moving jointly with the flexure such that when one v-groove of the model engages the movable pin, the flexure moves with spring resistance to motion, in order to accommodate any size of the model that is between a defined minimum and maximum size.

18. The computer system of claim 17, wherein the manufacturing step includes placing a first material on the model and thermoforming said first material around the model and the plurality of pins such that a negative of the model and the plurality of pins is formed in the first material.

19. The computer system of claim 18, wherein the manufacturing step includes performing CNC cutting of the first material or laser marking of the first material.

20. A non-transitory computer-readable storage medium storing a program which, when executed by a computer system, causes the computer system to perform a procedure comprising:
obtaining a nest provided with a flexure and a plurality of pins, the plurality of pins are arranged to mate with corresponding surfaces to conform to Maxwell's criterion in order to repeatedly locate the model;
obtaining the model, the model being provided with a number of v-grooves;
securing the model on the nest by using said number of v-grooves to engage corresponding pins of the plurality of pins of the nest; and,
performing a manufacturing step on the model;
wherein the flexure is connected to an alignment pin of the corresponding pins, the alignment ping being movable and moving jointly with the flexure such that when one v-groove of the model engages the movable pin, the flexure moves with spring resistance to motion, in order to accommodate any size of the model that is between a defined minimum and maximum size.
